(19) United States
(12) Patent Application Publication
(10) Pub. No.: US 2016/0251000 A1
(43) Pub. Date: Sep. 1, 2016

(54) METHODS AND SYSTEMS FOR MONITORING A SURFACE

(71) Applicant: GM GLOBAL TECHNOLOGY OPERATIONS LLC, Detroit, MI (US)

(72) Inventor: JERRY D. LOMAN, CLINTON TOWNSHIP, MI (US)

(21) Appl. No.: 14/632,870

(22) Filed: Feb. 26, 2015

(51) Int. Cl. B60S 1/60; B08B 13/00; G05D 7/06; G01J 5/10

(52) U.S. Cl. CPC B60S 1/603; G01J 5/10; B08B 13/00; G05D 7/0617; G01J 2005/0081

(57) ABSTRACT

Methods and systems are provided for monitoring a surface. A method includes: receiving thermographic data captured of a surface of a vehicle; comparing the thermographic data with baseline data to determine a difference; and selectively controlling a spray of fluid to the surface based on the difference.

### TECHNICAL FIELD

The present disclosure generally relates to infrared imaging, and more particularly relates to methods and systems for monitoring a surface for soiling and/or fluid concentration using infrared imaging.

### BACKGROUND

Various surfaces of a vehicle, such as windshields, windows, mirrors, headlamps, etc., require cleaning periodic for effective use. Fluid is sprayed on the surface at predefined amounts and at predefined times. In some cases, the fluid sprayed is not sufficient to clean the surface and the surface remains dirty and ineffective. In other cases, more than enough fluid is used to spray the surface and fluid is wasted.

Accordingly, it is desirable to provide methods and system for monitoring a surface for soils. It is further desirable to provide methods and systems for monitoring fluid concentration on the surface. Furthermore, other desirable features and characteristics of the present invention will become apparent from the subsequent detailed description of the invention and the appended claims, taken in conjunction with the accompanying drawings and this background of the invention.

### SUMMARY

Methods and systems are provided for monitoring a surface. A method includes: receiving thermographic data captured of a surface of a vehicle; comparing the thermographic data with baseline data to determine a difference; and selectively controlling a spray of fluid to the surface based on the difference.

A system includes a first module that receives thermographic data captured of a surface of a vehicle. A second module compares the thermographic data with baseline data to determine a difference. A third module selectively controls a spray of fluid to the surface based on the difference.

### DESCRIPTION OF THE DRAWINGS

The present disclosure will hereinafter be described in conjunction with the following drawing figures, wherein like numerals denote like elements, and:

FIG. 1 is a functional block diagram of a surface monitoring system of a vehicle in accordance with various exemplary embodiments;

FIG. 2 is a data flow diagram of a control module of the surface monitoring system in accordance with various exemplary embodiments; and

FIG. 3 is a flowchart of a method for monitoring the surface for soils and fluid in accordance with various exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to an application specific integrated circuit (ASIC), an electronic circuit, a processor (shared, dedicated, or group) and/or memory that executes or stores one or more software or firmware programs, a combinational logic circuit, and/or other suitable components that provide the described functionality.

Embodiments of the invention may be described herein in terms of functional and/or logical block components and various processing steps. It should be appreciated that such block components may be realized by any number of hardware, software, and/or firmware components configured to perform the specified functions. For example, exemplary embodiments may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that exemplary embodiments may be practiced in conjunction with any number of control systems, and that the vehicle systems described herein are merely exemplary embodiments.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in various embodiments.

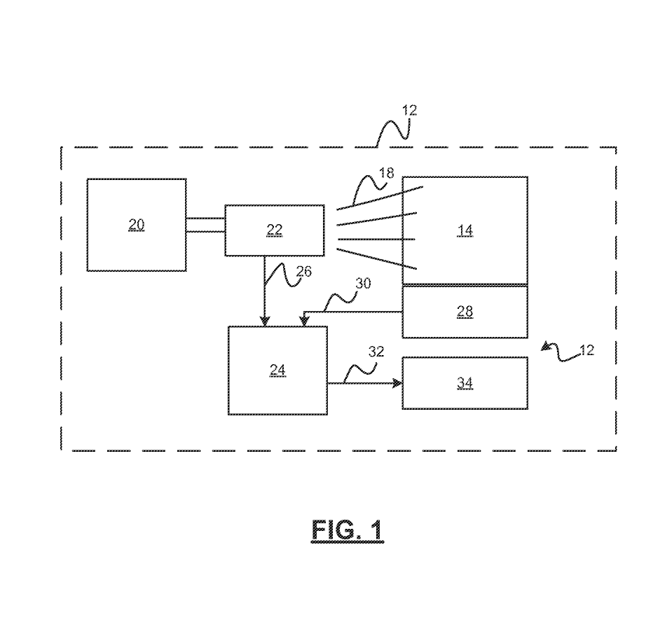

Referring now to FIG. 1, a vehicle 10 is shown to include a surface monitoring system 12 in accordance with various embodiments. As can be appreciated, the vehicle 10 may be any vehicle type including an automobile, an aircraft, a train, a watercraft, or any other vehicle type. For exemplary purposes, the disclosure will be discussed in the context of the vehicle 10 being an automobile. Although the figures shown herein depict an example with certain arrangements of elements, additional intervening elements, devices, features, or components may be present in an actual embodiments. It should also be understood that FIG. 1 is merely illustrative and may not be drawn to any scale.

As depicted in FIG. 1, the surface monitoring system 12 monitors a surface 14 of the vehicle 10 for soiling and/or monitors the surface 14 for a fluid concentration after the soiled surface 14 has been sprayed with a cleaning fluid. In various embodiments, the surface 14 is a part of the vehicle 10 such as, but not limited to, a headlamp, a windshield, a window, a mirror, or any other surface 14 of the vehicle 10 that may require cleaning. In various embodiments, the surface 14 is a surface associated with the monitoring system 12, such as, but not limited to a lens or other surface of an imaging device 28 that monitors another surface (not shown) of the vehicle 10.

The surface 14 is sprayed with a cleaning fluid 18 stored in a fluid reservoir 20 by way of an electronically controlled spray device 22. In various embodiments, the spray device 22 may be a single spray device or a collection of spray devices that are selectively controlled to spray a particular amount of cleaning fluid 18, to spray for a particular duration such that a particular amount of cleaning fluid 18 is sprayed, and/or to spray in a particular direction. A control module 24 generates control signals 26 to control the amount, duration, and/or direction of the spray by the spray device 22.

At at least one imaging device 28 is associated with the surface 14 and the control module 24. The imaging device 28 is, for example, an infrared camera that captures thermographic data 30 associated with the surface 14. The imaging device 28 provides the thermographic data 30 to the control module 24. The control module 24 assembles the thermographic data 30 into an image map representing thermographic values of the surface 14. The control module 24 evaluates the image map to determine whether the surface 14 is soiled enough to clean the surface 14, and/or to determine whether or not the spray of the cleaning fluid 18 is sufficient to clean the soiled areas of the surface 14.

In various embodiments, if the spray of the cleaning fluid 18 is not sufficient to clean the surface 14 (e.g., the spray device 22 has a defect or is clogged, or other reason), the control module 24 generates notification data 32. A notification device 34, such as an audio device, a display device, and/or a haptic device, receives the notification data 32 and notifies a user of the vehicle 10 of the inability to sufficiently clean the surface 14. As can be appreciated, the notification can be any type of notification including an audio notification, a visual notification, and/or a haptic notification and the notification data 32 can include any data sufficient to notify the user visually, haptically, or by audio.

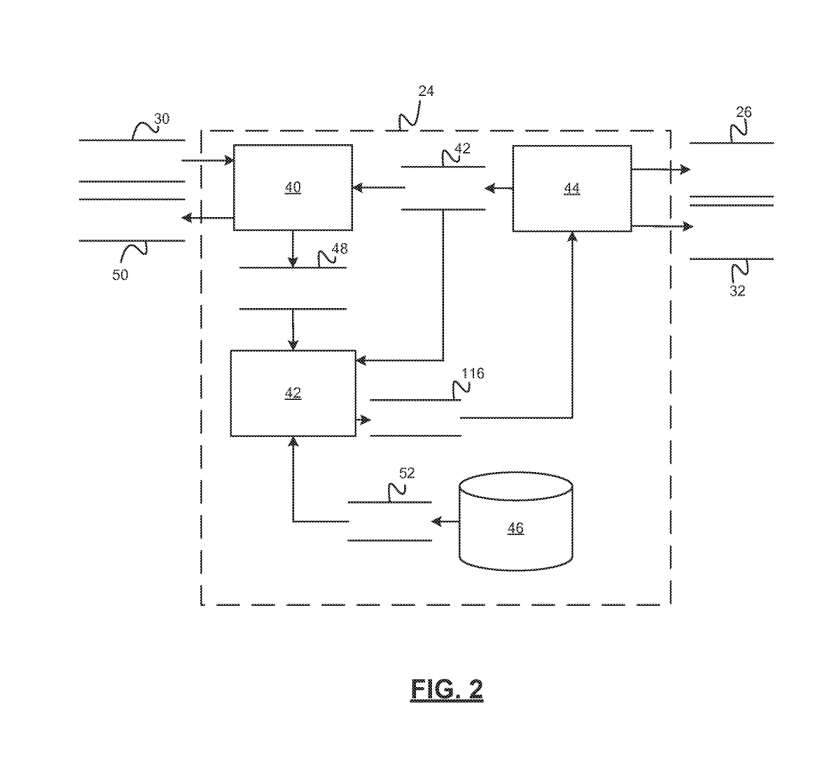

Referring now to FIG. 2 and with continued reference to FIG. 1, a dataflow diagram illustrates various embodiments of the control module 24 in greater detail. Various embodiments of the control module 24 according to the present disclosure may include any number of sub-modules. As can be appreciated, the sub-modules shown in FIG. 2 may be combined and/or further partitioned to similarly monitor the surface 14 for soils and the fluid concentration. Inputs to the control module 24 may be received from the imaging device 28 and/or other sensors, received from other control modules (not shown) of the vehicle 10, and/or determined by other sub-modules (not shown) of the control module 24. In various embodiments, the control module 24 includes an image capture module 40, an image comparator module 42, a fluid control module 44, and a map data datastore 46.

The image capture module 40 receives the thermographic data 30 generated by the imaging device 28 and assembles the thermographic data 30 into a thermographic image map 48. The thermographic image map 48 represents the thermal image of the surface 14. In various embodiments, the thermographic data 30 is received periodically and/or based on a request 50 for data generated by the image capture module 40. The request for data can be based on a surface status 51 that is generated by the fluid control module 44.

The image comparator module 42 receives as input the image map 48. The image comparator module 42 compares the image map 48 with another image map that is retrieved from the map data datastore 46. In various embodiments, the image maps stored in the image map datastore 46 include baseline image maps that represent a clean surface given various ambient conditions. In various embodiments, the image maps stored in the image map datastore 46 include baseline image maps that represent a sprayed surface given various ambient conditions. In various embodiments, the image maps stored in the image map datastore include the image maps 48 that were previously captured and stored.

The image comparator module 42 determines which image map to retrieve and compare based on a status 51 of the surface 14 received from the fluid control module 44. For example, when the status 51 indicates that fluid has not just been sprayed, then a baseline image map representing a clean surface may be retrieved. In another example, when the status 51 indicates that the fluid has just been sprayed, then either a baseline image map or a previously stored image map may be retrieved.

The image comparator module 42 compares the image maps to determine thermal differences 5 (e.g., differences. The image comparator module 42 generates a difference map 54 representing the thermal differences (e.g., at each of the x, y coordinates) of the surface 14.

The fluid control module 44 receives as input the difference map 54 that was generated by the comparator module 42. The fluid control module 44 evaluates the difference map 54 and generates the control signals 26 and/or the notification data 32 based on the evaluation. For example, when the differences in an area of the surface exceed a threshold (e.g., indicate that an areas is soiled), then the fluid control module 44 generates fluid control signals 26 to control an amount of fluid, a duration of spray, and/or a direction of fluid to be sprayed on the surface. The fluid control module 44 determines the amount and/or the direction based on the number of differences, and/or the areas where the differences exist.

In various embodiments, the fluid control module 44 generates notification data 32 when, after repeated attempts to clean the surface 14 by generating X number of control signals 26, and it is determined that the surface 14 is unable to be cleaned, the fluid control module 44 generates notification data 32 to notify a user of the inability to clean the surface 14. The notification data 32 may include a message or other indication (e.g., audio or haptic) that the surface 14 is unable to be cleaned or that the spray device 22 is unable to clean the surface 14.

The fluid control module 44 updates the status 54 based on the generation of the control signals 26 and/or the notification data 32. For example, if the fluid control signals 26 were just generated then, the fluid control module 44 updates status 51 to indicate that the surface 14 has just been sprayed. In another example, if the fluid control signals 26 have not been generated for a predetermined time (e.g., a defined time between cleanings), the fluid control module 44 updates the status 51 to indicate that information is needed.

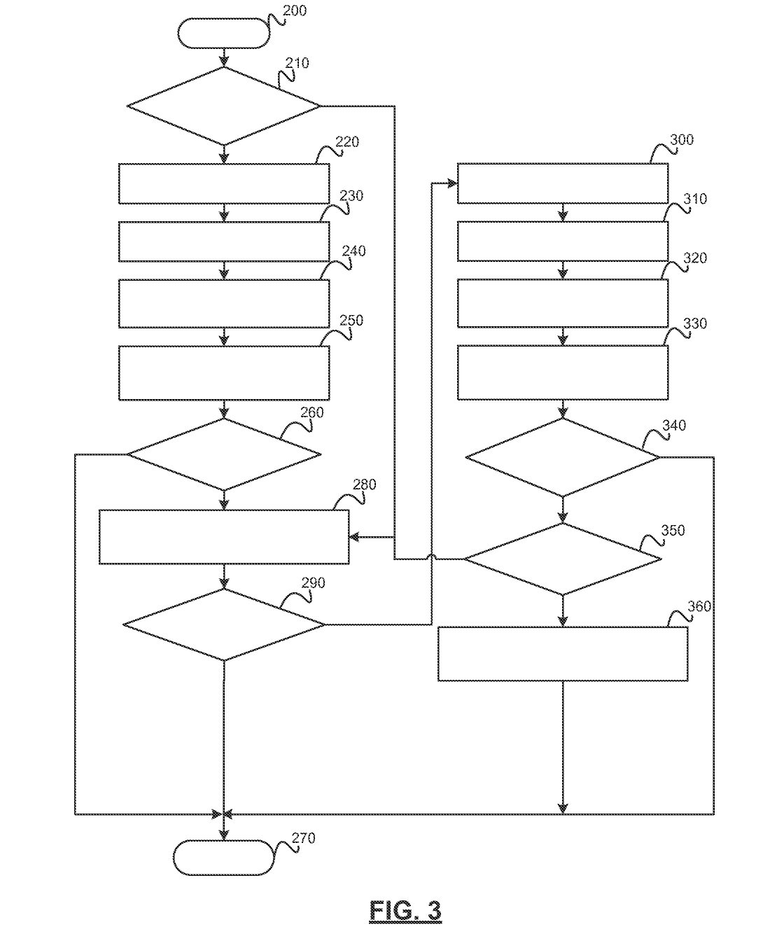

Referring now to FIG. 3, and with continued reference to FIGS. 1 and 2, a flowchart illustrates a control method that can be performed by the surface monitoring system 12 in accordance with various embodiments. As can be appreciated in light of the disclosure, the order of operation within the method is not limited to the sequential execution as illustrated in FIG. 3, but may be performed in one or more varying orders as applicable and in accordance with the present disclosure.

As can further be appreciated, the method of FIG. 3 may be scheduled to run at predetermined time intervals during operation of the vehicle 10 and/or may be scheduled to run based on predetermined events.

In one example, the method may begin at 200. It is determined whether the surface 14 is to be evaluated before cleaning at 210. If it is desired to evaluate the surface 14 before a cleaning at 210, the method may proceed to step 280.

Otherwise, if it is desired that the surface 14 be evaluated before cleaning at 210, thermographic data 30 of the surface 14 is captured at 220 and an image map 48 is generated based on the thermographic data 30 at 230. The baseline “clean” image map 52 is retrieved from the map data datastore 46 at 240. The baseline image map 52 and the current image map 48 are evaluated at 250 and 260. In particular, differences are computed between corresponding areas of the baseline image map 52 and the current image map 48 at 250. If a difference or a certain number of differences do not exceed a threshold value (e.g., a thermal value indicating that the soil exists) at 260, then it is concluded that the surface 14 does not need cleaning and the method ends at 270.

If, however, a difference or a certain number of differences exceed the threshold value (e.g., the thermal value indicating that the soil exists) at 260, then the fluid control signals 26 are generated at 280 to control an amount of spray and/or a direction of the spray. In various embodiments, the amount and/or direction is based on the area of the surface 14 that has the difference that exceeds the threshold value.

Thereafter, the cleaning of the surface 14 may optionally be evaluated at 290-340. If it is not desired that the cleaning be evaluated at 290, the method may end at 270. If it is desired that the cleaning be evaluated at 290, the thermographic data 30 of the surface 14 is captured again after the control signals 26 are generated and the fluid 18 has landed on the surface 14 at 300. A current image map 48 representing the fluid 18 on the surface 14 is generated based on the thermographic data 30 at 310. A baseline image map 52 representing either a desired spray, or the soiled areas of the surface 14 (e.g., the previously captured image map 48) is retrieved from the map datastore 46 at 320. The current image map 48 is compared with the baseline image map at 330 and 340. In particular, differences are computed between corresponding areas of the current image map 48 and the baseline image map 52 at 330. If a difference or a certain number of differences do not exceed a threshold value (e.g., a thermal value indicating that the fluid exists in the area) at 340, then it is concluded that the spray concentration was sufficient to clean the soiled areas and the method ends at 270. If, however, a difference or a certain number of differences exceed a threshold value (e.g., a thermal value indicating that the fluid exists in the area) at 340, then it is concluded that the spray concentration was not sufficient to clean the soiled areas and the number of spray repetitions is evaluated at 350. If the number of spray repetitions does not exceed a threshold at 350, the method continues with generating the control signals 26 to control an amount of spray and/or a direction of the spray at 280. In various embodiments, the amount and/or direction is based on the area of the surface 14 that has the difference that exceeds the threshold value.

If, however, the number of spray repetitions does exceed a threshold at 350, the notification data 32 is generated to notify a user that the surface 14 is not clean or that the spray device 22 is unable to effectively clean the soiled surface 14 at 360 and the method may end at 270.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for monitoring a surface, the method comprising:
receiving thermographic data captured of a surface of a vehicle;
comparing the thermographic data with baseline data to determine a difference; and
selectively controlling a spray of fluid to the surface based on the difference.

2. The method of claim 1, wherein the baseline data represents a clean surface.

3. The method of claim 1, further comprising capturing the thermographic data before fluid has been sprayed to the surface.

4. The method of claim 1, wherein the baseline data represents a sprayed surface.

5. The method of claim 1, further comprising capturing the thermographic data after fluid has been sprayed to the surface.

6. The method of claim 1, further comprising generating an image map based on the thermographic data, and wherein the comparing comprises comparing the image map with a baseline image map of the baseline data to determine one or more differences in areas of the map.

7. The method of claim 1, further comprising selectively generating notification data to notify a user based on the comparing.

8. The method of claim 1, further comprising:
receiving second thermographic data captured of the surface of the vehicle after the controlling the spray of the fluid;
comparing the second thermographic data with second baseline data to determine a second difference; and
selectively controlling the spray of the fluid to the surface based on the second difference.

9. The method of claim 8, wherein the second baseline data comprises the thermographic data.

10. The method of claim 8, wherein the second baseline data represents a sprayed surface.

11. A system for monitoring a surface, the system comprising:
a first module that receives thermographic data captured of a surface of a vehicle;
a second module that compares the thermographic data with baseline data to determine a difference; and
a third module that selectively controlling a spray of fluid to the surface based on the difference.

12. The system of claim 11, wherein the baseline data represents a clean surface.

13. The system of claim 11, further comprising an infrared imaging device that captures the thermographic data before fluid has been sprayed to the surface.

14. The system of claim 11, wherein the baseline data represents a sprayed surface.

15. The system of claim 11, further comprising an infrared imaging device that captures the thermographic data after fluid has been sprayed to the surface.

16. The system of claim 11, wherein the first module generates an image map based on the thermographic data, and wherein the second module compares the image map with a baseline image map of the baseline data to determine one or more differences in areas of the map.

17. The system of claim 11, wherein the third module selectively generates notification data to notify a user based on the comparing.

18. A vehicle, comprising:
a surface;
an infrared imaging device that captures thermographic data of the surface; and
a control module that receives the thermographic data, that compares the thermographic data with baseline data to determine a difference, and that selectively controls a spray of fluid to the surface based on the difference.

19. The vehicle of claim 18, the infrared imaging device captures the thermographic data before fluid has been sprayed to the surface, and wherein the baseline data represents a clean surface.

20. The vehicle of claim 18, wherein the infrared imaging device captures the thermographic data after fluid has been sprayed to the surface, and wherein the baseline data represents at least one of a sprayed surface and a previous surface.
